(19) United States
(12) Patent Application Publication
(10) Pub. No.: US 2021/0266909 A1
(43) Pub. Date: Aug. 26, 2021

(54) TERMINAL APPARATUS, BASE STATION APPARATUS, AND COMMUNICATION METHOD

(71) Applicants: SHARP KABUSHIKI KAISHA, Sakai City, Osaka (JP); FG Innovation Company Limited, Tuen Mun (HK)

(72) Inventors: HUI-FA LIN, Sakai City, Osaka (JP); SHOICHI SUZUKI, Sakai City, Osaka (JP); TOMOKI YOSHIMURA, Sakai City, Osaka (JP); TOSHIZO NOGAMI, Sakai City, Osaka (JP); WATARU OUCHI, Sakai City, Osaka (JP); TAEWOO LEE, Sakai City, Osaka (JP)

(73) Assignees: SHARP KABUSHIKI KAISHA, Sakai City, Osaka (JP); FG Innovation Company Limited, Tuen Mun (HK)

(21) Appl. No.: 17/252,665

(22) PCT Filed: May 21, 2019
(86) PCT No.: PCT/JP2019/020009

§ 371 Date: Dec. 15, 2020

(30) Foreign Application Priority Data
Jun. 15, 2018 (JP) 2018-114398

(51) Int. Cl. H04W 72/04; H04W 76/11; H04L 5/00

(52) U.S. Cl. CPC H04W 72/0493; H04W 72/042; H04L 5/0051; H04W 72/0446; H04W 76/11; H04W 72/0466

(57) ABSTRACT

A terminal apparatus includes a receiver configured to monitor a search space set of a control resource set. A physical downlink control channel (PDCCH) candidate to be monitored is allocated to the search space set, based at least on a maximum number C_{PDCCH}^{max, slot} of non-overlapped control channel elements (CCEs) expected to be monitored by the terminal apparatus in a slot. In a case that the control resource set satisfies at least one of multiple conditions, the CCE is a CCE of the non-overlapped CCEs. The multiple conditions include a condition where the CCE corresponds to different types of the search space set.

### FIELD

The present disclosure is related to a terminal apparatus, a base station apparatus, and a communication method of a terminal apparatus and a base station apparatus. This application claims priority to JP 2018-114398 filed on Jun. 15, 2018, the contents of which are incorporated herein by reference.

### BACKGROUND ART

In the 3^{rd} Generation Partnership Project (3GPP), a radio access method and a radio network for cellular mobile communications (hereinafter referred to as “Long Term Evolution (LTE)”or “Evolved Universal Terrestrial Radio Access (EUTRA)”) have been studied. In LTE, a base station apparatus is also referred to as an evolved NodeB (eNodeB), and a terminal apparatus is also referred to as a User Equipment (UE). LTE is a cellular communication system in which multiple areas are deployed in a cell structure, with each of the multiple areas being covered by a base station apparatus. A single base station apparatus may manage multiple serving cells.

3GPP has been studying a next generation standard (New Radio or NR) (NPL 1) to make a proposal for International Mobile Telecommunication (IMT)-2020, a standard for a next-generation mobile communication system, standardized by the International Telecommunication Union (ITU). NR is required to satisfy requirements for three scenarios including enhanced Mobile BroadBand (eMBB), massive Machine Type Communication (mMTC), and Ultra Reliable and Low Latency Communication (URLLC) in a single technology framework.

### CITATION LIST

### Non Patent Literature

NPL 1: “New SID proposal: Study on New Radio Access Technology,” RP-160671, NTT DOCOMO INC., 3GPP TSG RAN Meeting #71, Goteborg, Sweden, 7th to 10 Mar. 2016.

### SUMMARY OF INVENTION

### Technical Problem

One aspect of the present disclosure provides a terminal apparatus capable of efficiently performing communication, a communication method used for the terminal apparatus, a base station apparatus capable of efficiently performing communication, and a communication method used for the terminal apparatus.

### Solution to Problem

A first aspect of the present disclosure is a terminal apparatus for performing communication including a receiver configured to monitor a search space set of a control resource set, wherein a physical downlink control channel (PDCCH) candidate to be monitored is allocated to the search space set, based on at least a maximum number C_{PDCCH}^{max, slot} of non-overlapped control channel elements (CCEs) expected to be monitored by the terminal apparatus in a slot, in a case that the control resource set satisfies at least one of multiple conditions, the CCE that is monitored is one of the non-overlapped CCEs, and the multiple conditions include a condition where the CCE that is monitored corresponds to different types of the search space set.

A second aspect of the present disclosure is a base station apparatus including a receiver configured to monitor a search space set of a control resource set, wherein a physical downlink control channel (PDCCH) candidate to be monitored is allocated to the search space set, based at least on a maximum number C_{PDCCH}^{max,slot} of non-overlapped control channel elements (CCEs) expected to be monitored by a terminal apparatus in a slot, in a case that the control resource set satisfies at least one of multiple conditions, the CCE expected to be monitored is one of the non-overlapped CCEs, and the multiple conditions include a condition where the CCE expected to be monitored corresponds to different types of the search space set.

A third aspect of the present disclosure is a communication method of a terminal apparatus for performing communication, the communication method including a receiver configured to monitor a search space set of a control resource set, wherein a physical downlink control channel (PDCCH) candidate to be monitored is allocated to the search space set, based at least on a maximum number C_{PDCCH}^{max,slot} of non-overlapped control channel elements (CCEs) expected to be monitored by the terminal apparatus in a slot, in a case that the control resource set satisfies at least one of multiple conditions, the CCE expected to be monitored is one of the non-overlapped CCEs, and the multiple conditions include a condition where the CCE expected to be monitored corresponds to different types of the search space set.

### Advantageous Effects of Invention

According to the present disclosure, a terminal apparatus and a base station apparatus can each efficiently perform communication.

### BRIEF DESCRIPTION OF DRAWINGS

FIG. 1 is a conceptual diagram of a radio communication system according to the present disclosure.

FIG. 2 illustrates a relationship between N^{slot}_{symb}, a subcarrier spacing configuration μ, a slot configuration, and a CP configuration according to the present disclosure.

FIG. 3 illustrates an example of a resource grid in a subframe according to the present disclosure.

FIG. 4 illustrates a terminal apparatus according to present disclosure.

FIG. 5 illustrates a base station apparatus according to the present disclosure.

FIG. 6 illustrates a method for determining whether a certain CCE is a non-overlapped CCE or an overlapped CCE in allocating a PDCCH candidate according to the present disclosure.

FIG. 7 illustrates a procedure for allocating the number of usable non-overlapped CCEs and the number of monitorable PDCCH candidates for a search space set in a slot according to the present disclosure.

### DESCRIPTION OF EMBODIMENTS

Embodiments of the present disclosure will be described subsequently.

A parameter or information indicating one or multiple values may be the parameter or the information including at least a parameter or information indicating the one or multiple values. A higher layer parameter may correspond to a single higher layer parameter. The higher layer parameter may be an Information Element (IE) including multiple parameters.

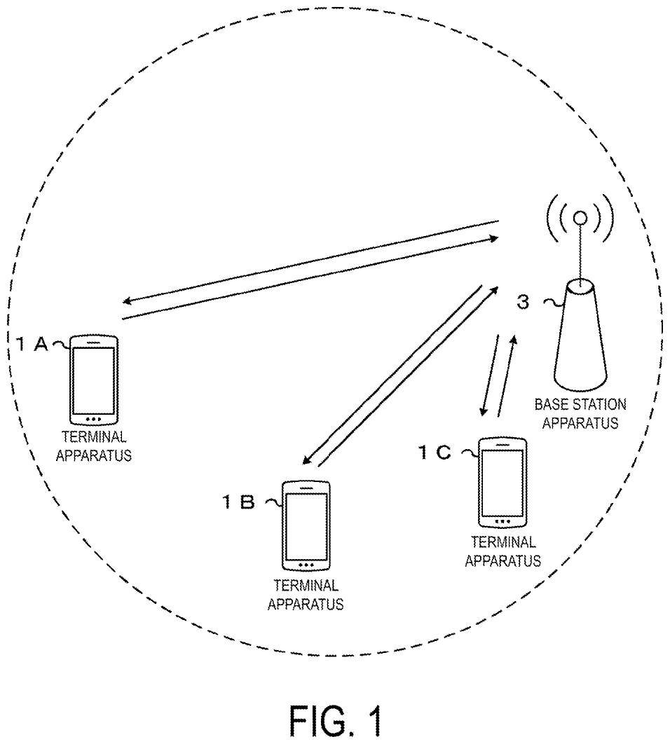

FIG. 1 is a conceptual diagram of a radio communication system according to the present disclosure. In FIG. 1, the radio communication system includes terminal apparatuses 1A to 1C and a base station apparatus 3. Hereinafter, the terminal apparatuses 1A to 1C are each also referred to as a terminal apparatus 1.

Hereinafter, a frame configuration will be described.

In the radio communication system according to the present disclosure, at least Orthogonal Frequency Division Multiplexing (OFDM) is used. An OFDM symbol is a unit of a time domain for the OFDM. The OFDM symbol includes at least one or multiple subcarriers. The OFDM symbol is converted into a time-continuous signal in generating a baseband signal.

A SubCarrier Spacing (SCS) may be Δf=2 μ*15 kHz. For example, a subcarrier spacing configuration μ may be configured as any of 0, 1, 2, 3, 4, and/or 5. For a Bandwidth Part (BWP), the subcarrier spacing configuration _{I}I. may be provided by a higher layer parameter.

In a radio communication system according to the present disclosure, a time unit T_{c} represents a length in the time domain. The time unit T_{c} may be T_{c}=1/(Δfₘₐₓ*N_{f}). Δfₘₐₓ may be the maximum value of the subcarrier spacing supported in the radio communication system. Δfₘₐₓ may be 480 kHz. N_{f} may be 4096. Constant κ may be Δfₘₐₓ*N_{f}/(Δf_{ref}N_{f,ref})=64. Δf_{ref} may be 15 kHz. N_{f,ref} may be 2048.

The constant κ may be a value indicating a relationship between a reference subcarrier spacing and T_{c}. The constant κ may be used for a length of a subframe. The number of slots included in the subframe may be based on at least based the constant κ. Δf_{ref} is the reference subcarrier spacing, and N_{f,ref} is a value corresponding to the reference subcarrier spacing.

A transmission in the downlink and/or a transmission in the uplink includes a frame of 10 ms. A frame includes 10 subframes. A length of the subframe is 1 ms. A length of the frame may be unrelated to the subcarrier spacing Δf. For example, a frame configuration may be provided regardless of μ. The length of the subframe may be unrelated to the subcarrier spacing Δf. For example, a subframe configuration may be provided regardless of μ.

For a subcarrier spacing configuration μ, the number and indices of slots included in a subframe may be provided. For example, a first slot number n^{μ}ₛ may be provided in ascending order ranging from 0 to N^{subframe,μ}ₛₗₒₜ₋₁ in the subframe. For the subcarrier spacing configuration μ, the number and indices of slots included in a frame may be provided. For example, a second slot number n^{μ}_{s,f} may be provided in ascending order ranging from 0 to N^{frame,μ}ₛₗₒₜ−1 in the frame. N^{slot}_{symb} consecutive OFDM symbols may be included in one slot. N^{slot}_{symb} may be based on at least part or all of a slot configuration and/or a Cyclic Prefix (CP) configuration. The slot configuration may be provided by a higher layer parameter slot_configuration. The CP configuration may be based on at least a higher layer parameter. The CP configuration may be based on at least dedicated Radio Resource Control (RRC)signaling. The first slot number and the second slot number are also referred to as a slot number (slot index).

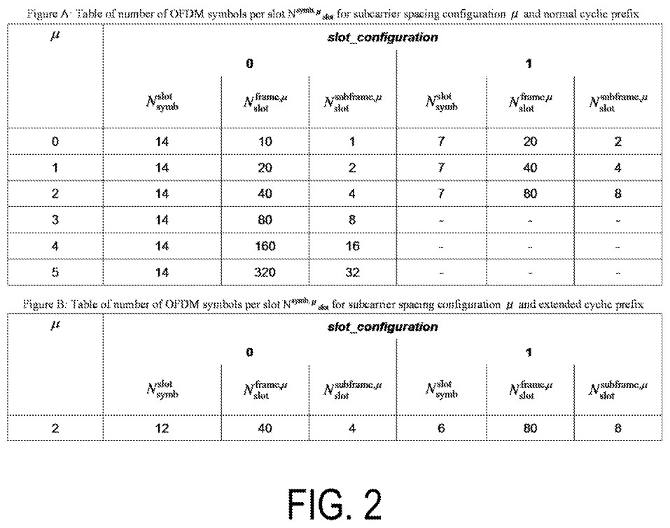

FIG. 2 illustrates a relationship between N^{slot}_{symb}, the subcarrier spacing configuration μ, a slot configuration, and a CP configuration according to the present disclosure. In FIG. 2A, in a case that the slot configuration is 0, the subcarrier spacing configuration μ is 2, and the CP configuration is a normal cyclic prefix (normal CP), N^{slot}_{symb}=14, N^{frame,μ}ₛₗₒₜ=40, and N^{subframe,μ}ₛₗₒₜ=4 hold. In FIG. 2B, in a case that the slot configuration is 0, the subcarrier spacing configuration μ is 2 and the CP configuration is an extended cyclic prefix (extended CP), N^{slot}_{symb}=12, N^{frame,μ}ₛₗₒₜ=40, and N^{subframe,μ}ₛₗₒₜ=4 hold. The N^{slot}_{symb} in the slot configuration 0 may support twice the number of the N^{slot}_{symb} in the slot configuration 1.

Physical resources will be described subsequently.

An antenna port is defined such that a channel on which a symbol on one antenna port is conveyed can be inferred from a channel on which another symbol on the same antenna port is conveyed. In a case that a large scale property of the channel on which the symbol on one antenna port is conveyed can be inferred from the channel on which the symbol on another antenna port is conveyed, the two antenna ports are said to be Quasi Co-Located (QCL). The large scale property may include at least a long term performance of the channel. The large scale property may include at least some of delay spread, Doppler spread, Doppler shift, average gain, average delay, and beam parameters (spatial Rx parameters). A first antenna port and a second antenna port being QCL with respect to a beam parameter may mean that a reception beam assumed by the reception side for the first antenna port may be the same as a reception beam assumed by the reception side for the second antenna port. The first antenna port and the second antenna port being QCL with respect to a beam parameter may mean that a transmission beam assumed by the reception side for the first antenna port may be the same as a transmission beam assumed by the reception side for the second antenna port. In a case that the large scale property of the channel on which the symbol on one antenna port is conveyed can be inferred from the channel on which the symbol on another antenna port is conveyed, the terminal apparatus 1 may assume that the two antenna ports are QCL. Two antenna ports being QCL may mean that the two antenna ports are assumed to be QCL.

For configuring subcarrier spacing and setting carriers, a resource grid including N^{μ}_{RB,x}N^{RB}_{sc} subcarriers and N^{(μ)}_{symb}N^{subframe,μ}_{symb} OFDM symbols is provided. N^{μ}_{RB,x} may indicate the number of resource blocks provided for the subcarrier spacing configuration μ for a carrier x. N^{μ}_{RB,x} may indicate the maximum number of resource blocks provided for the subcarrier spacing configuration μ for a carrier x. The carrier x indicates either a downlink (DL) carrier or an uplink (UL) carrier. In other words, x is “DL” or “UL.” N^{μ}_{RB,x} is referred as including N^{μ}_{RB,DL} and/or N^{μ}_{RB,UL}. N^{RB}_{sc} may indicate the number of subcarriers included in one resource block. At least one resource grid may be provided for each antenna port p and/or for each subcarrier spacing configuration μ and/or for each Transmission direction configuration. The transmission direction includes at least DL and UL. Hereinafter, a set of parameters including at least some of the antenna port p, the subcarrier spacing configuration μ, and the transmission direction configuration is also referred to as a first radio parameter set. For example, one resource grid may be provided for each first radio parameter set.

A carrier included in a serving cell in the downlink is referred to as a downlink carrier (or a downlink component carrier). A carrier included in a serving cell in the uplink is referred to as an uplink carrier (or an uplink component carrier). The downlink component carrier and the uplink component carrier are collectively referred to as a component carrier (or a carrier).

Each element in the resource grid provided for each first radio parameter set is referred to as a resource element. The resource element is identified by an index k_{sc} of a frequency domain and an index l_{sym} of a time domain. For a first radio parameter set, a resource element is identified by an index k_{sc} of the frequency domain and an index l_{sym} of the time domain. The resource element identified by the index k_{sc} of the frequency domain and the index l_{sym} of the time domain is also referred to as a resource element (k_{sc}, l_{sym}). The index k_{sc} of the frequency domain indicates any value from 0 to N^{μ}_{RB}N^{RB}_{sc}−1. N^{μ}_{RB,} may be the number of resource blocks provided for the subcarrier spacing configuration μ. N^{RB}_{sc} is the number of subcarriers included in a resource block, and N^{RB}_{sc}=12. The index k_{sc} of the frequency domain may correspond to a subcarrier index k_{sc}. The index l_{sym} of the time domain may correspond to an OFDM symbol index l_{sym}.

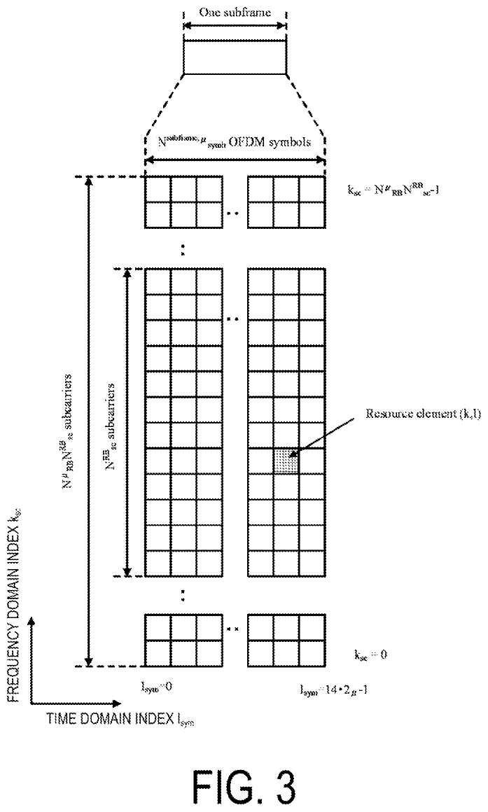

FIG. 3 illustrates an example of a resource grid in a subframe according to the present disclosure. In the resource grid of FIG. 3, a horizontal axis is the index l_{sym} of the time domain and a vertical axis is the index k_{sc} of the frequency domain. In one subframe, the frequency domain of the resource grid includes N^{μ}_{RB}N^{RB}_{sc} subcarriers. In one subframe, the time domain of the resource grid may include 14*2 μ OFDM symbols. One resource block includes N^{RB}_{sc} subcarriers. The time domain of the resource block may correspond to one OFDM symbol. The time domain of the resource block may correspond to 14 OFDM symbols. The time domain of the resource block may correspond to one or multiple slots. The time domain of the resource block may correspond to one subframe.

The terminal apparatus 1 may receive indication to perform transmission and/or reception by using only a subset of the resource grid. The subset of the resource grids is also referred to as a BWP, and the BWP may be based on at least part or all of higher layer parameters and/or the DCI. The BWP is also referred to as a bandwidth part (BP). In other words, the terminal apparatus 1 need not be indicated to perform transmission and reception using all sets of resource grids. In other words, the terminal apparatus 1 may be indicated to perform transmission and reception using some frequency resources in the resource grid. One BWP may include multiple resource blocks in the frequency domain. One BWP may include multiple resource blocks continuous in the frequency domain. The BWP configured for the downlink carrier is also referred to as a downlink BWP. The BWP configured for the uplink carrier is also referred to as an uplink BWP.

One or multiple downlink BWPs may be configured for the terminal apparatus 1. The terminal apparatus 1 may attempt to receive a physical channel (for example, a PDCCH, a Physical Downlink Shared Channel (PDSCH), a Synchronization Signal (SS)/Physical Broadcast Channel (PBCH), or the like) in one downlink BWP of one or multiple downlink BWPs. The one downlink BWP is also referred to as an active downlink BWP.

One or multiple uplink BWPs may be configured for the terminal apparatus 1. The terminal apparatus 1 may attempt to transmit a physical channel (for example, a Physical Uplink Control CHannel (PUCCH), a Physical Uplink Shared CHannel (PUSCH), a Physical Random Access CHannel (PRACH), or the like) in one uplink BWP of one or multiple uplink BWPs. The one uplink BWP is also referred to as an activated uplink BWP.

A set of downlink BWPs may be configured for each serving cell. The set of downlink BWPs may include one or multiple downlink BWPs. A set of uplink BWPs may be configured for each serving cell. The set of uplink BWPs may include one or multiple uplink BWPs.

The higher layer parameter is a parameter included in higher layer signaling. The higher layer signaling may be a Radio Resource Control (RRC) signaling or a Medium Access Control (MAC) Control Element (CE). The higher layer signaling may be RRC layer signaling or MAC layer signaling.

The higher layer signaling may be common RRC signaling. The common RRC signaling may include at least some of the following features C1 to C3.

Feature C1) Being mapped to a Broadcast Control CHannel (BCCH)logical channel or a Common Control CHannel (CCCH)logical channel.

Feature C2) Including at least radioResourceConfigCommon information element.

Feature C3) Being mapped to a PBCH.

The radioResourceConfigCommon information element may include information indicating a configuration commonly used in a serving cell. The configuration commonly used in the serving cell may include at least a PRACH configuration. The PRACH configuration may indicate at least one or multiple random access preamble indices. The PRACH configuration may indicate at least a time/frequency resource of a PRACH.

The higher layer signaling may be dedicated RRC signaling. The dedicated RRC signaling may include at least some of the following features D1 and D2.

Feature D1) Being mapped to a Dedicated Control CHannel (DCCH)logical channel.

Feature D2) Including at least radioResourceConfigDedicated information element.

The radioResourceConfigDedicated information element may include at least information indicating a configuration specific to the terminal apparatus 1. The radioResourceConfigDedicated information element may include at least information indicating a BWP configuration. The BWP configuration may indicate at least a frequency resource of the BWP.

For example, a Master Information Block (MIB), first system information, and second system information may be included in the common RRC signaling. Moreover, a higher layer message mapped to the DCCH logical channel and including at least radioResourceConfigCommon may be included in the common RRC signaling. A higher layer message mapped to the DCCH logical channel and not including the radioResourceConfigCommon information element may be included in the dedicated RRC signaling. A higher layer message mapped to the DCCH logical channel and including at least the radioResourceConfigDedicated information element may be included in the dedicated RRC signaling.

The first system information may indicate at least a time index of a Synchronization Signal (SS) block, which is also referred to as an SS/PBCH block or SS/PBCH. The first system information may include at least information of a PRACH resource. The first system information may include at least information on a configuration for initial connection. The second system information may be system information other than the first system information.

The radioResourceConfigDedicated information element may include at least information of the PRACH resource. The radioResourceConfigDedicated information element may include at least information related to the configuration for initial connection.

A physical channel and a physical signal according to various aspects of the present disclosure will be described subsequently.

An uplink physical channel may correspond to a set of resource elements that conveys information generated in a higher layer. The uplink physical channel is a physical channel used in the uplink carrier. In the radio communication system according to the present disclosure, at least some of the following uplink physical channels are used: PUCCH, PUSCH, PRACH.

The PUCCH may be used to transmit Uplink Control Information (UCI). The uplink control information includes part or all of Channel State Information (CSI), a Scheduling Request (SR), and a Hybrid Automatic Repeat request ACKnowledgement (HARQ-ACK) corresponding to a Transport block (TB)(Medium Access Control Protocol Data Unit (MAC PDU), Downlink-Shared Channel (DL-SCH), Physical Downlink Shared Channel (PDSCH).

The HARQ-ACK may include at least a HARQ-ACK bit corresponding to at least one transport block. The HARQ-ACK bit may indicate an acknowledgement (ACK) or a negative-acknowledgement (NACK) corresponding to one or multiple transport blocks. The HARQ-ACK may include at least a HARQ-ACK codebook including one or multiple HARQ-ACK bits. The HARQ-ACK bit corresponding to one or multiple transport blocks may be the HARQ-ACK bit corresponding to a PDSCH including the one or multiple transport blocks.

The HARQ-ACK bit may indicate an ACK or a NACK corresponding to one Code Block Group (CBG) included in the transport block. The HARQ-ACK is also referred to as HARQ feedback, HARQ information, and HARQ control information.

The Scheduling Request (SR) may be used at least to request a PUSCH resource for an initial transmission. A scheduling request bit may be used to indicate either a positive SR or a negative SR. The scheduling request bit indicating the positive SR is also referred to as a “positive SR is transmitted.” The positive SR may indicate that the PUSCH resource for the initial transmission is requested by the terminal apparatus 1. The positive SR may indicate that a scheduling request is triggered by a higher layer. The positive SR may be transmitted in a case that a scheduling request is indicated to be transmitted by the higher layer. The scheduling request bit indicating the negative SR is also referred to as a “negative SR is transmitted.” The negative SR may indicate that the PUSCH resource for the initial transmission is not requested by the terminal apparatus 1. The negative SR may indicate that a scheduling request is not triggered by the higher layer. The negative SR may be transmitted in a case that a scheduling request is not indicated to be transmitted by the higher layer.

The channel state information may include at least some of a Channel Quality Indicator (CQI), a Precoder Matrix Indicator (PMI), and a Rank Indicator (RI). The CQI is an indicator associated with channel quality (for example, propagation strength), and the PMI is an indicator indicating a precoder. The RI is an indicator indicating a transmission rank (or the number of transmission layers).

The PUCCH supports PUCCH formats (from PUCCH format 0 to PUCCH format 4). The PUCCH format may be mapped to the PUCCH and transmitted. The PUCCH format may be transmitted on the PUCCH. The PUCCH format being transmitted may be the PUCCH being transmitted.

The PUSCH is used at least to transmit the transport block (TB, MAC PDU, Uplink-Shared CHannel (UL-SCH), and PUSCH). The PUSCH may be used to transmit at least some of the transport block, the HARQ-ACK, the channel state information, and the scheduling request. The PUSCH is used at least to transmit random access message 3.

The PRACH may be used at least to transmit a random access preamble (random access message 1). The PRACH may be used at least to indicate some of an initial connection establishment procedure, a handover procedure, a connection re-establishment procedure, synchronization (timing adjustment) for PUSCH transmission, and a request for the PUSCH resource. The random access preamble may be used to notify the base station apparatus 3 of an index (random access preamble index) provided by a higher layer of the terminal apparatus 1.

In FIG. 1, the following uplink physical signals are used for uplink radio communication: UpLink Demodulation Reference Signal (UL DMRS), Sounding Reference Signal (SRS), UpLink Phase Tracking Reference Signal (UL PTRS). The uplink physical signals may not be used to transmit information output from a higher layer, but used by a physical layer.

The UL DMRS is associated with transmission of a PUSCH and/or a PUCCH. The UL DMRS is multiplexed on the PUSCH or the PUCCH. The base station apparatus 3 may use the UL DMRS in order to perform channel compensation of the PUSCH or the PUCCH. Transmission of both a PUSCH and an UL DMRS associated with the PUSCH will be hereinafter referred to as transmission of a PUSCH. Transmission of both a PUCCH and an UL DMRS associated with the PUCCH will be hereinafter referred to as transmission of a PUCCH. The UL DMRS associated with the PUSCH is also referred to as an UL DMRS for a PUSCH. The UL DMRS associated with the PUCCH is also referred to as an UL DMRS for a PUCCH.

The SRS may not be associated with transmission of the PUSCH or the PUCCH. The base station apparatus 3 may use the SRS for measuring a channel state. The SRS may be transmitted at the end of a subframe in an uplink slot or in a predetermined number of OFDM symbols from the end.

The UL PTRS may be a reference signal that is used at least for phase tracking. The UL PTRS may be associated with an UL DMRS group including at least an antenna port used for one or multiple UL DMRSs. The association of the UL PTRS with an UL DMRS group may mean that the antenna port for the UL PTRS and some of the antenna ports included in the UL DMRS group are at least QCL. The UL DMRS group may be identified based at least on the antenna port of the lowest index for the UL DMRS included in the UL DMRS group. The UL PTRS may be mapped to the lowest index antenna port of one or multiple antenna ports to which one codeword is mapped. In a case that one codeword is mapped to at least a first layer and a second layer, the UL PTRS may be mapped to the first layer. The UL PTRS may not be mapped to the second layer. The index of the antenna port to which the UL PTRS is mapped may be based on at least the downlink control information.

In FIG. 1, the following downlink physical channels are used for downlink radio communication from the base station apparatus 3 to the terminal apparatus 1: PBCH, PDCCH, PDSCH. The downlink physical channels are used by the physical layer for transmission of information output from a higher layer.

The PBCH is used at least to transmit a Master Information Block (MIB) (BCH, or Broadcast Channel). The PBCH may be transmitted at a predetermined transmission interval. The PBCH may be transmitted at an interval of 80 ms or 160 ms. Contents of information included in the PBCH may be updated every 80 ms. Some or all of the contents of information included in the PBCH may be updated every 160 ms. The PBCH may include 288 subcarriers. The PBCH may include 2, 3, or 4 OFDM symbols. The MIB may include information related to an identifier (index) of a synchronization signal. The MIB may include information indicating at least some of numbers of a slot, a subframe, and/or a radio frame in which the PBCH is transmitted.

The PDCCH is used at least to transmit Downlink Control Information (DCI). The PDCCH may be transmitted including at least the downlink control information. The downlink control information is also referred to as a DCI format. The downlink control information may include at least a downlink grant or an uplink grant. The DCI format used for scheduling the PDSCH is also referred to as a downlink DCI format. The DCI format used for scheduling the PUSCH is also referred to as an uplink DCI format. The downlink grant is also referred to as downlink assignment or downlink allocation.

In various aspects of the present disclosure, unless otherwise specified, the number of resource blocks indicates the number of resource blocks in the frequency domain.

The downlink grant is used at least for scheduling of a single PDSCH in a single serving cell.

The uplink grant is used at least for scheduling of a single PUSCH in a single serving cell.

A single physical channel may be mapped to a single serving cell. A single physical channel may be mapped to a single BWP configured for a single carrier included in a single serving cell.

The terminal apparatus 1 may be configured with one or multiple COntrol REsource SETs (CORESETs). The terminal apparatus 1 monitors the PDCCH in one or multiple control resource sets. Here, monitoring the PDCCH in the one or multiple control resource sets may include monitoring one or multiple PDCCHs respectively corresponding to the one or multiple control resource sets. The PDCCH may include one or multiple PDCCH candidates and/or a PDCCH candidate set. Monitoring the PDCCH may include monitoring and detecting the PDCCH and/or the DCI format transmitted via the PDCCH.

The control resource set may indicate a time-frequency domain to which one or multiple PDCCHs can be mapped. The control resource set may be a domain in which the terminal apparatus 1 monitors the PDCCH. The control resource set may include continuous resources (localized resources). The control resource set may include non-continuous resources (distributed resources).

In the frequency domain, the unit of mapping the control resource set may use a resource block. In the frequency domain, for example, the unit of mapping the control resource set may be six resource blocks. In the time domain, the unit of mapping the control resource set may use an OFDM symbol. In the time domain, for example, the unit of mapping the control resource set may be one OFDM symbol.

Mapping the control resource set to the resource block may be based on at least a higher layer parameter. The higher layer parameter may include a bitmap for a resource block group (RBG). The resource block group may be provided by six continuous resource blocks.

The number of OFDM symbols of the control resource set may be based on at least a higher layer parameter.

A certain control resource set may be a Common control resource set. The common control resource set may be a control resource set configured commonly to multiple terminal apparatuses 1. The common control resource set may be based on at least some of an MIB, first system information, second system information, common RRC signaling, and a cell identity (ID). For example, a time resource and/or frequency resource of the control resource set configured to monitor the PDCCH used for scheduling the first system information may be based on at least the MIB.

The control resource set configured based on the MIB is also referred to as CORESET #0. CORESET #0 may be a control resource set of index #0.

A control resource set may be a Dedicated control resource set. The dedicated control resource set may be a control resource set configured exclusively for the terminal apparatus 1. The dedicated control resource set may be based on at least dedicated RRC signaling and some of the values of C-RNTI.

The set of PDCCH candidates monitored by the terminal apparatus 1 may be defined from the perspective of a search space. In other words, the PDCCH candidate set monitored by the terminal apparatus 1 may be provided by the search space.

A search space may include one or multiple PDCCH candidates of one or multiple Aggregation levels. The aggregation level for the PDCCH candidate may indicate the number of CCEs of the PDCCH candidate. The PDCCH candidate may be mapped to one or multiple CCEs.

The terminal apparatus 1 may monitor at least one or multiple search spaces in the slot for which Discontinuous reception (DRX) is not configured. The DRX may be based on at least a higher layer parameter. The terminal apparatus 1 may monitor at least one or multiple search space sets in the slot for which the DRX is not configured.

A search space set may include at least one or multiple search spaces. The search space set may include at least some of a type 0-PDCCH common search space, a type 0A-PDCCH common search space, a type 1-PDCCH common search space, a type 2-PDCCH common search space, a type 3-PDCCH common search space, and/or a UE-specific Search Space (USS). The type 0-PDCCH common search space may be configured at least for monitoring a first downlink DCI format. The type 1-PDCCH common search space may be configured at least for monitoring a first downlink DCI format. The UE-specific search space may be configured at least for monitoring some of the first downlink DCI format, a second downlink DCI format, a first uplink DCI format, and/or a second uplink DCI format. The first downlink DCI format may be DCI format 1_0. The second downlink DCI format may be DCI format 1_1. The first uplink DCI format may be DCI format 0_0. The second uplink DCI format may be DCI format 0_1.

The type 0-PDCCH common search space, the type 0A-PDCCH common search space, the type 1-PDCCH common search space, the type 2-PDCCH common search space, and the type 3-PDCCH common search space are also referred to as a Common Search Space (CSS).

Each search space set may be associated with at least a single control resource set. Each search space set may be included in a single control resource set. Each search space set may be provided an index of the control resource set associated with the search space set.

The type 0-PDCCH common search space may be used at least for the DCI format having a Cyclic Redundancy Check (CRC) sequence scrambled with a System Information-Radio Network Temporary Identifier (SI-RNTI). The configuration of the control resource set associated with at least the type 0-PDCCH common search space may be based on at least a higher layer parameter searchSpaceZero. The higher layer parameter searchSpaceZero may be included in the MIB. The higher layer parameter searchSpaceZero may indicate at least one of or both the number of resource blocks included in the control resource set associated with at least the type 0-PDCCH common search space, and the number of OFDM symbols included in the control resource set. The higher layer parameter searchSpaceZero may be indicated by an information field included in the MIB.

The type 0A-PDCCH common search space may be used at least for the DCI format having a CRC sequence scrambled with a SI-RNTI. The configuration of the control resource set associated with at least the type 0A-PDCCH common search space may be based on at least a higher layer parameter searchSpace-OSI. The higher layer parameter searchSpace-OSI may be included in the higher layer information element PDCCH-ConfigCommon.

The type 1-PDCCH common search space may be used at least for the DCI format having a CRC sequence scrambled with a Random Access-Radio Network Temporary Identifier (RA-RNTI), a CRC sequence scrambled with a Temporary Common-Radio Network Temporary Identifier (TC-RNTI), and/or a CRC sequence scrambled with a Common-Radio Network Temporary Identifier (C-RNTI). The RA-RNTI may be based on at least a time/frequency resource of the random access preamble transmitted by the terminal apparatus 1. The TC-RNTI may be provided by a PDSCH that is scheduled in the DCI format having the CRC sequence scrambled with the RA-RNTI (also referred to as message 2 or a random access response grant). The C-RNTI may be based on at least a PDSCH that is scheduled in the DCI format having the CRC sequence scrambled with the TC-RNTI (also referred to as message 4 or a contention resolution).

The type 2-PDCCH common search space may be used at least for the DCI format having a CRC sequence scrambled with a Paging-Radio Network Temporary Identifier (P-RNTI).

The type 3-PDCCH common search space may be used at least for the DCI format having a CRC sequence scrambled with an Interruption-Radio Network Temporary Identifier (INT-RNTI), a CRC sequence scrambled with a Slot Format Indication-Radio Network Temporary Identifier (SFI-RNTI), a CRC sequence scrambled with a Transmit Power Control PUSCH-Radio Network Temporary Identifier (TPC-PUSCH-RNTI), a CRC sequence scrambled with a Transmit Power Control PUCCH-Radio Network Temporary Identifier (TPC-PUCCH-RNTI), a CRC sequence scrambled with a Transmit Power Control Sounding Reference Symbols-Radio Network Temporary Identifier (TPC-SRS-RNTI), a CRC sequence scrambled with a Configured Scheduling-Radio Network Temporary Identifier (CS-RNTI), a CRC sequence scrambled with a Semi-Persistent CSI-Radio Network Temporary Identifier (SP-CSI-RNTI), and/or a CRC sequence scrambled with a C-RNTI.

The UE-specific search space may be used at least for the DCI format having the CRC sequence scrambled with the C-RNTI.

The common control resource set may include at least one of the CSS and the USS. The dedicated control resource set may include at least one of the CSS and the USS. Whether a certain search space set is the CSS or the USS may be based on at least a higher layer parameter.

A physical resource of the search space includes a Control Channel Element (CCE) of the control channel. The CCE includes a predetermined number of Resource Element Groups (REGs). For example, the CCE may include six REGs. The REG may include one OFDM symbol in one Physical Resource Block (PRB). In other words, the REG may include 12 Resource Elements (REs). The PRB is also referred to as a Resource Block (RB).

The PDSCH is used at least to transmit the transport block. The PDSCH may be used at least to transmit a random access message 2 (random access response). The PDSCH may be used at least to transmit system information including parameters used for initial access.

In FIG. 1, the following downlink physical signals are used for the downlink radio communication: an SS, a DownLink DeModulation Reference Signal (DL DMRS), a Channel State Information-Reference Signal (CSI-RS), a DownLink Phrase Tracking Reference Signal (DL PTRS), a Tracking Reference Signal (TRS). The downlink physical signals may not be used for transmitting information output from a higher layer but is used by the physical layer.

The synchronization signal is used for the terminal apparatus 1 to establish synchronization in a frequency domain and/or a time domain in the downlink. The synchronization signal includes a Primary Synchronization Signal (PSS) and a Secondary Synchronization Signal (SSS).

An SS block (SS/PBCH block) includes at least some of the PSS, the SSS, and the PBCH. Respective antenna ports of some of the PSS, SSS, and PBCH included in the SS block may be the same. Some or all of the PSS, SSS, and PBCH included in the SS block may be mapped to continuous OFDM symbols. Respective CP configurations of some of the PSS, SSS, and PBCH included in the SS block may be the same. Respective subcarrier spacing configurationsμ of some of the PSS, SSS, and PBCH included in the SS block may be the same.

The DL DMRS is associated with transmission of the PBCH, PDCCH and/or PDSCH. The DL DMRS is multiplexed on the PBCH, PDCCH and/or PDSCH. The terminal apparatuses 1 may use the DL DMRS corresponding to the PBCH, PDCCH, or PDSCH in order to perform channel compensation of the PBCH, PDCCH or PDSCH. Hereinafter, transmission of both the PBCH and the DL DMRS associated with the PBCH is referred to as transmission of the PBCH. Transmission of both the PDCCH and the DL DMRS associated with the PDCCH is referred to as transmission of the PDCCH. Transmission of both the PDSCH and the DL DMRS associated with the PDSCH is referred to as transmission of the PDSCH. The DL DMRS associated with the PBCH is also referred to as a DL DMRS for the PBCH. The DL DMRS associated with the PDSCH is also referred to as a DL DMRS for the PDSCH. The DL DMRS associated with the PDCCH is also referred to as a DL DMRS associated with the PDCCH.

The DL DMRS may be individually configured for the terminal apparatus 1. The sequence of the DL DMRS may be based on at least a parameter individually configured for the terminal apparatus 1. The sequence of the DL DMRS may be based on at least a UE specific value (e.g., C-RNTI, or the like). The DL DMRS may be individually transmitted for the PDCCH and/or the PDSCH.

The CSI-RS may be a signal at least used to calculate channel state information. A pattern of the CSI-RS expected by the terminal apparatus may be provided by at least a higher layer parameter.

The PTRS may be a signal at least used to compensate for phase noise. A pattern of the PTRS expected by the terminal apparatus may be based on at least a higher layer parameter and/or the DCI.

The DL PTRS may be associated with a DL DMRS group that includes at least an antenna port used for one or multiple DL DMRSs. The association of the DL PTRS with the DL DMRS group may mean that the antenna port for the DL PTRS and some of the antenna ports included in the DL DMRS group are at least QCL. The DL DMRS group may be identified based at least on the antenna port of the lowest index of antenna ports for the DL DMRS included in the DL DMRS group.

The TRS may be a signal at least used for time and/or frequency synchronization. A pattern of the TRS expected by the terminal apparatus may be based on at least a higher layer parameter and/or the DCI.

Downlink physical channels and downlink physical signals are collectively referred to as downlink signals. Uplink physical channels and uplink physical signals are collectively referred to as uplink signals. The downlink signals and the uplink signals are collectively referred to as physical signals. The downlink signal and the uplink signal are collectively referred to as signals. The downlink physical channels and the uplink physical channels are collectively referred to as physical channels. The downlink physical signals and the uplink physical signals are collectively referred to as physical signals.

The Broadcast CHannel (BCH), the Uplink-Shared CHannel (UL-SCH), and the Downlink-Shared CHannel (DL-SCH) are transport channels. A channel used in a Medium Access Control (MAC) layer is referred to as a transport channel. A unit of the transport channel used in the MAC layer is also referred to as a transport block (TB) or a MAC PDU. A Hybrid Automatic Repeat reQuest (HARD) is controlled for each transport block in the MAC layer. The transport block is a unit of data that the MAC layer delivers to the physical layer. In the physical layer, the transport block is mapped to a codeword, and a modulation process is performed for each codeword.

The base station apparatus 3 and the terminal apparatus 1 exchange (transmit and/or receive) higher layer signaling in the higher layer. For example, the base station apparatus 3 and the terminal apparatus 1 may transmit and/or receive Radio Resource Control (RRC) signaling (Radio Resource Control (RRC) message or Radio Resource Control (RRC) information) in a Radio Resource Control (RRC) layer. Furthermore, the base station apparatus 3 and the terminal apparatus 1 may transmit and/or receive, in the MAC layer, a MAC Control Element (CE). The RRC signaling and/or the MAC CE is also referred to as higher layer signaling.

The PUSCH and the PDSCH are used at least to transmit the RRC signaling and/or the MAC CE. The RRC signaling transmitted from the base station apparatus 3 through the PDSCH may be signaling common to multiple terminal apparatuses 1 in a serving cell. The signaling common to the multiple terminal apparatuses 1 in the serving cell is also referred to as common RRC signaling. The RRC signaling transmitted from the base station apparatus 3 through the PDSCH may be signaling dedicated to a certain terminal apparatus 1 (also referred to as dedicated signaling or UE specific signaling). The signaling dedicated to the terminal apparatus 1 is also referred to as dedicated RRC signaling. A higher layer parameter specific to the serving cell may be transmitted by using the signaling common to the multiple terminal apparatuses 1 in the serving cell or the signaling dedicated to the certain terminal apparatus 1. The UE-specific higher layer parameter may be transmitted by using the signaling dedicated to the certain terminal apparatus 1.

A Broadcast Control CHannel (BCCH), a Common Control CHannel (CCCH), and a Dedicated Control CHannel (DCCH) are logical channels. For example, the BCCH is a higher layer channel used to transmit the MIB. Furthermore, the Common Control CHannel (CCCH) is a higher layer channel used to transmit information common to the multiple terminal apparatuses 1. The CCCH may be used for the terminal apparatus 1 that is not in an RRC connected state, for example. Furthermore, the Dedicated Control CHannel (DCCH) is a higher layer channel at least used to transmit control information dedicated to the terminal apparatus 1 (dedicated control information). The DCCH may be used for the terminal apparatus 1 that is in an RRC connected state, for example.

The BCCH in the logical channel may be mapped to the BCH, the DL-SCH, or the UL-SCH in the transport channel. The CCCH in the logical channel may be mapped to the DL-SCH or the UL-SCH in the transport channel. The DCCH in the logical channel may be mapped to the DL-SCH or the UL-SCH in the transport channel.

The UL-SCH in the transport channel may be mapped to the PUSCH in the physical channel. The DL-SCH in the transport channel may be mapped to the PDSCH in the physical channel. The BCH in the transport channel may be mapped to the PBCH in the physical channel.

A terminal apparatus 1 according to the present disclosure will be described subsequently.

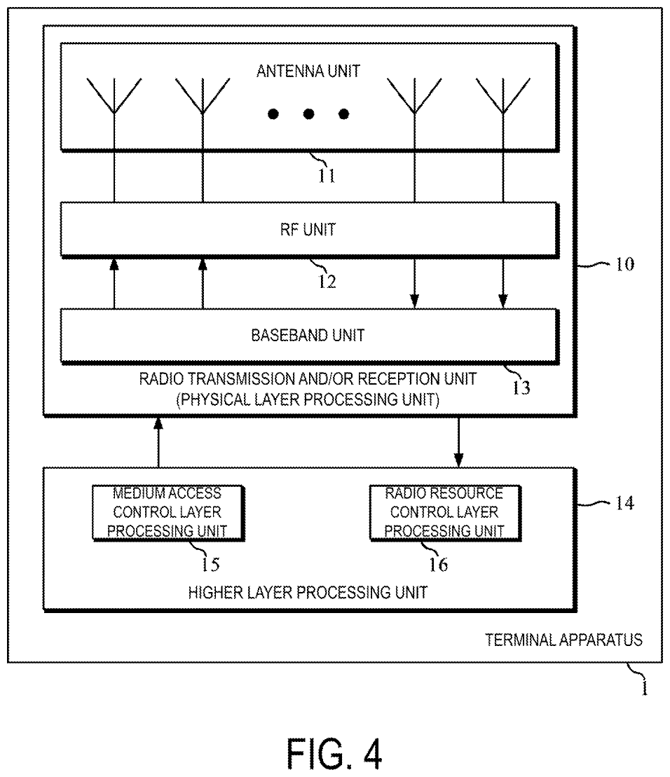

FIG. 4 illustrates a terminal apparatus 1 according to the present disclosure. As illustrated, the terminal apparatus 1 includes a radio transmission and/or reception unit 10 and a higher layer processing unit 14. The radio transmission and/or reception unit 10 includes at least some of an antenna unit 11, a Radio Frequency (RF) unit 12, and a baseband unit 13. The higher layer processing unit 14 includes at least some of a medium access control layer processing unit 15 and a radio resource control layer processing unit 16. The radio transmission and/or reception unit 10 is also referred to as a transmitter, a receiver, or a physical layer processing unit.

The higher layer processing unit 14 outputs uplink data (transport block) generated by a user operation or the like, to the radio transmission and/or reception unit 10. The higher layer processing unit 14 performs processing of a MAC layer, a Packet Data Convergence Protocol (PDCP) layer, a Radio Link Control (RLC) layer, and an RRC layer.

The medium access control layer processing unit 15 included in the higher layer processing unit 14 performs processing of the MAC layer.

The radio resource control layer processing unit 16 included in the higher layer processing unit 14 performs processing of the RRC layer. The radio resource control layer processing unit 16 manages various types of configuration information/parameters of the terminal apparatus 1. The radio resource control layer processing unit 16 sets various types of configuration information/parameters based on a higher layer signaling received from the base station apparatus 3. Specifically, the radio resource control layer processing unit 16 sets the various configuration information/parameters according to the information for indicating the various configuration information/parameters received from the base station apparatus 3. The configuration information may include information related to the processing or configurations of the physical channel, the physical signal (or physical layer), the MAC layer, the PDCP layer, the RLC layer, and the RRC layer. The parameters may be higher layer parameters.

The radio transmission and/or reception unit 10 performs processing of the physical layer, such as modulation, demodulation, coding, and decoding. The radio transmission and/or reception unit 10 demultiplexes, demodulates, and decodes a received physical signal and outputs the decoded information to the higher layer processing unit 14. The radio transmission and/or reception unit 10 generates a physical signal by performing modulation and coding of data, and generating a baseband signal (conversion into a time continuous signal), and transmits the physical signal to the base station apparatus 3.

The RF unit 12 converts (down converts) a signal received via the antenna unit 11 into a baseband signal by orthogonal demodulation and removes unnecessary frequency components. The RF unit 12 outputs a processed analog signal to the baseband unit.

The baseband unit 13 converts the analog signal input from the RF unit 12 into a digital signal. The baseband unit 13 removes a portion corresponding to a Cyclic Prefix (CP) from the converted digital signal, performs a Fast Fourier Transform (FFT) of the signal from which the CP has been removed, and extracts a signal in the frequency domain.

The baseband unit 13 generates an OFDM symbol by performing Inverse Fast Fourier Transform (IFFT) of the data, adds CP to the generated OFDM symbol, generates a baseband digital signal, and converts the baseband digital signal into an analog signal. The baseband unit 13 outputs the converted analog signal to the RF unit 12.

The RF unit 12 removes unnecessary frequency components from the analog signal input from the baseband unit 13 by using a low-pass filter, up-converts the analog signal into a signal of a carrier frequency, and transmits the up-converted signal via the antenna unit 11. Furthermore, the RF unit 12 amplifies power. Furthermore, the RF unit 12 may have a function of controlling transmit power. The RF unit 12 is also referred to as a transmit power control unit.

A base station apparatus 3 according to the present disclosure will be described subsequently.

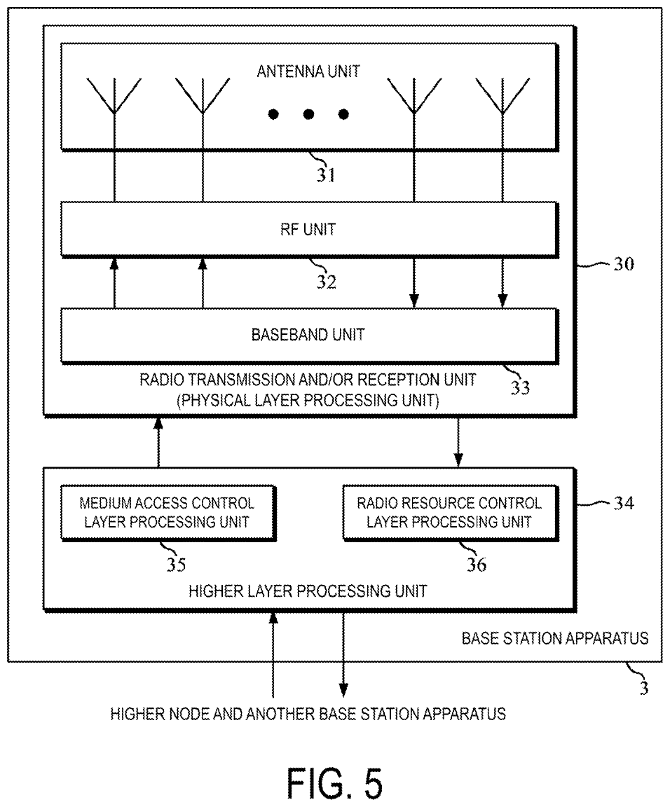

FIG. 5 illustrates a base station apparatus 3 according to the present disclosure. As illustrated, the base station apparatus 3 includes a radio transmission and/or reception unit 30 and a higher layer processing unit 34. The radio transmission and/or reception unit 30 includes an antenna unit 31, an RF unit 32, and a baseband unit 33. The higher layer processing unit 34 includes a medium access control layer processing unit 35 and a radio resource control layer processing unit 36. The radio transmission and/or reception unit 30 is also referred to as a transmitter, a receiver or a physical layer processing unit.

The higher layer processing unit 34 performs processing of a MAC layer, a PDCP layer, an RLC layer, and an RRC layer.

The medium access control layer processing unit 35 included in the higher layer processing unit 34 performs processing of the MAC layer.

The radio resource control layer processing unit 36 included in the higher layer processing unit 34 performs processing of the RRC layer. The radio resource control layer processing unit 36 generates, or acquires from a higher node, downlink data (transport block) allocated on a PDSCH, system information, an RRC message, a MAC CE, and the like, and outputs the data to the radio transmission and/or reception unit 30. Furthermore, the radio resource control layer processing unit 36 manages various types of configuration information/parameters for each of the terminal apparatuses 1. The radio resource control layer processing unit 36 may set various types of configuration information/parameters for each of the terminal apparatuses 1 via higher layer signaling. For example, the radio resource control layer processing unit 36 transmits/reports information indicating various types of configuration information/parameters. The configuration information may include information related to the processing or configurations of the physical channel, the physical signal (or physical layer), the MAC layer, the PDCP layer, the RLC layer, and the RRC layer. The parameters may be higher layer parameters.

The functionality of the radio transmission and/or reception unit 30 is similar to the functionality of the radio transmission and/or reception unit 10 in FIG. 4, and, therefore, description thereof is omitted.

Each of the units having the reference designators 10 to 16 included in the terminal apparatus 1 may be configured as a circuit. Each of the units having the reference designators 30 to 36 included in the base station apparatus 3 may be configured as a circuit.

A coded bit sequence of the PDCCH downlink control information is scrambled with a scrambling sequence c(i). The scrambling sequence c(i) for scrambling the coded bit sequence of the PDCCH downlink control information may be initialized based on at least a value n_{RNTI} and/or a value n_{ID}. In a case that a higher layer parameter pdcch-DMRS-ScramblingID is configured for one control resource set and the type of the search space set to which the PDCCH is mapped is a USS, a value of the value n_{ID} may be provided by the higher layer parameter pdcch-DMRS-ScramblingID, and the value n_{RNTI} may be provided by the C-RNTI. In a case that the higher layer parameter pdcch-DMRS-ScramblingID is not configured for one control resource set or the type of the search space set to which the PDCCH is mapped is a CSS, a value of the value n_{ID} may be provided by a physical layer cell ID N_{ID}^{cell}, and the value n_{RNTI} may be zero. The search space set here may be that included in the control resource set. The types of search space set include the CSS and the USS. For example, the CSS may include at least some of the type 0-PDCCH common search space, the type 0A-PDCCH common search space, the type 1-PDCCH common search space, the type 2-PDCCH common search space, and/or the type 3-PDCCH common search space. The USS may include at least the UE-specific search space. Note that in a case that multiple control resource sets are configurable, the higher layer parameter pdcch-DMRS-ScramblingID may be configured for each control resource set.

A DMRS sequence for PDCCH is scrambled with the scrambling sequence c(i). The scrambling sequence c (i) for scrambling the DMRS sequence for PDCCH may be initialized at least by the value n_{ID}. Here, n_{ID} may be independently configured, unlike nip for the scrambling sequence of the PDCCH. In a case that the higher layer parameter pdcch-DMRS-ScramblingID is configured for the control resource set to which the PDCCH is mapped and the type of the search space set is a USS, the value of n_{ID} may be provided by the higher layer parameter pdcch-DMRS-ScramblingID. In a case that the higher layer parameter pdcch-DMRS-ScramblingID is not configured, the value of n_{ID} may be provided by N_{ID}^{cell}.

The radio transmission and/or reception unit 10 in the terminal apparatus 1 and the radio transmission and/or reception unit 30 in the base station apparatus 3 may determine whether the CCE is a non-overlapped CCE. In a case that the CCE satisfies a predetermined condition A, the CCE may be determined to be a non-overlapped CCE. In a case that the CCE does not satisfy the predetermined condition A, the CCE may be determined not to be a non-overlapped CCE. In a case that the CCE does not satisfy the predetermined condition A, the CCE may be determined to be an overlapped CCE. The predetermined condition A may include at least some of the following conditions A1 to A5.

Condition A1: The CCE corresponds to a different control resource set (and/or a control resource set of a different index).

Condition A2: The CCE corresponds to the different first symbol for reception of each PDCCH candidate (and/or the first symbol of a different symbol index).

Condition A3: The CCE corresponds to a search space set of a different type.

Condition A4: The control resource set corresponding to the CCE is configured with the parameter pdcch-DMRS-ScramblingID.

Condition A5: The value N_{ID} is different, the value N_{ID} being used for initializing the scrambling sequence c(i) for the DMRS sequence for PDCCH corresponding to each search space set corresponding to the CCE.

As another example, in a case that the CCE satisfies a predetermined condition B, the CCE may be determined to be a non-overlapped CCE. In a case that the CCE does not satisfy the predetermined condition B, the CCE may be determined to be an overlapped CCE. The predetermined condition B may include at least some of the following conditions B1 to B4.

Condition B1: The CCE corresponds to a different control resource set (and/or a control resource set of a different index).

Condition B2: The CCE corresponds to the different first symbol for reception of each PDCCH candidate (and/or the first symbol of a different symbol index).

Condition B3: The CCE is scrambled with a different scrambling sequence for reception of each PDCCH candidate (e.g., different parameters are used to generate the scrambling sequences).

Condition B4: A DMRS reference signal sequence for PDCCH corresponding to each search space set corresponding to the CCE is different (e.g., different parameters are used to generate the reference signal sequences).

Note that a relationship between the condition A and the conditions A1 to A5 is obtained, for example, by a method of taking a logical sum of the conditions A1 to A5. In other words, it may be assumed that the condition A is satisfied in a case that at least one of the conditions A1 to A5 is satisfied. Similarly, an example of a relationship between the condition B and the conditions B1 to B4 may be obtained by using a method taking a logical sum of the conditions B1 to B4.

Whether the CCE is a non-overlapped CCE or an overlapped CCE may be determined based at least on a predetermined condition a. The predetermined condition a may include at least some of the following conditions a1 to a5.

Condition a1: Whether or not the CCE corresponds to a different control resource set (and/or a control resource set of a different index).

Condition a2: Whether or not the CCE corresponds to the different first symbol for reception of each PDCCH candidate (and/or the first symbol of a different symbol index).

Condition a3: Whether or not the CCE corresponds to a search space set of a different type.

Condition a4: Whether or not the control resource set corresponding to the CCE is configured with the parameter pdcch-DMRS-ScramblingID.

Condition a5: Whether or not the value Nip used for initializing the scrambling sequence c(i) for the DMRS sequence for PDCCH corresponding to each search space set corresponding to the CCE is different.

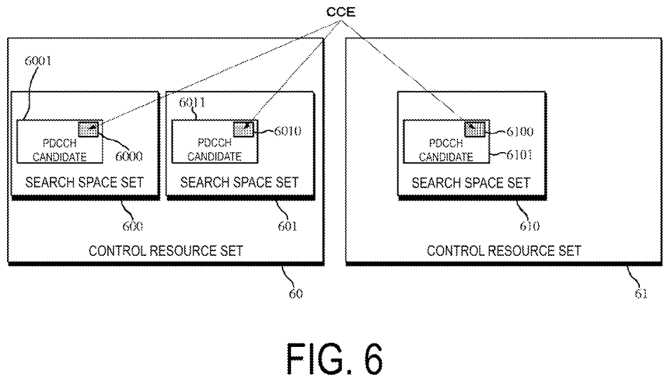

FIG. 6 illustrates a method for determining whether a certain CCE is a non-overlapped CCE or an overlapped CCE in allocating a PDCCH candidate according to the present disclosure. In FIG. 6, a first control resource set 60 and a second control resource set 61 are configured for the terminal apparatus 1. The first control resource set 60 includes a first search space set 600 and a second search space set 601. The second control resource set 61 includes a third search space set 610. The first search space set 600 includes a first PDCCH candidate 6001. The second search space set 601 includes a second PDCCH candidate 6011. The third search space set 610 includes a third PDCCH candidate 6101. The first PDCCH candidate 6001 is at least mapped to a first CCE 6000. The second PDCCH candidate 6011 is at least mapped to a second CCE 6010. The third PDCCH candidate 6101 is at least mapped to a third CCE 6100. For example, in a first example, in a case that the first control resource set 60 is configured with the first space set 600 and the first PDCCH candidate 6001 included in the first search space set 600 is mapped to at least the first CCE 6000, and the second control resource set 61 is configured with the search space set 610 and the PDCCH candidate 6101 included in the search space set 610 is mapped to at least the third CCE 6100, the first CCE 6000 and the third CCE 6100 may be determined to be non-overlapped CCEs. Here, an index of the first CCE 6000 may be the same as or different from an index of the third CCE 6100. Here, a subcarrier to which the first CCE 6000 corresponds may be the same as or different from a subcarrier to which the third CCE 6100 corresponds. Here, resource elements of the first CCE 6000 may be the same as or different from resource elements of the third CCE 6100.

In a second example, in a case that the first control resource set 60 is configured with the first search space set 600 and the first PDCCH candidate 6001 included in the first search space set 600 is mapped to at least the first CCE 6000, the first control resource set 60 is configured with the second search space set 601 and the second PDCCH candidate 6011 included in the second search space set 601 is mapped to at least the second CCE 6010, and the first OFDM symbol of a monitoring occasion for the first search space set 600 is different from the first OFDM symbol of a monitoring occasion for the second search space set 601, the first CCE 6000 and the second CCE 6010 may be determined to be non-overlapped CCEs. Here, an index of the first CCE 6000 may be the same as or different from an index of the second CCE 6010. Here, a subcarrier to which the first CCE 6000 corresponds may be the same as or different from a subcarrier to which the second CCE 6010 corresponds.

The first OFDM symbol of the monitoring occasion for the search space set may be provided by a higher layer parameter monitoringSymbolsWithinSlot to be monitored. The first OFDM symbol being different for reception of each PDCCH candidate means the first OFDM symbol of a first PDCCH candidate is different from the first OFDM symbol of a second PDCCH candidate in a certain control resource set in a slot.

In a third example, in a case that the first control resource set 60 is configured with the first search space set 600 and the first PDCCH candidate 6001 included in the first search space set 600 is mapped to at least the first CCE 6000, the first control resource set 60 is configured with the second search space set 601 and the second PDCCH candidate 6011 included in the second search space set 601 is mapped to at least the second CCE 6010, the first OFDM symbol of the monitoring occasion for the first search space set 600 is the same as the first OFDM symbol of the monitoring occasion for the second search space set 601, and the type of the search space set to which the first search space set 600 belongs is different from the type of the search space set to which the second search space set 601 belongs, the first CCE 6000 and the second CCE 6010 may be determined to be non-overlapped CCEs. Here, an index of the first CCE 6000 may be the same as or different from an index of the second CCE 6010. Here, a subcarrier to which the first CCE 6000 corresponds may be the same as or different from a subcarrier to which the second CCE 6010 corresponds. Here, resource elements of the first CCE 6000 may be the same as or different from resource elements of the second CCE 6010.

In a fourth example, in a case that the first control resource set 60 is configured with the first search space set 600 and the first PDCCH candidate 6001 included in the first search space set 600 is mapped to at least the first CCE 6000, the first control resource set 60 is configured with the second search space set 601 and the second PDCCH candidate 6011 included in the second search space set 601 is mapped to at least the second CCE 6010, the first OFDM symbol of the monitoring occasion for the first search space set 600 is the same as the first OFDM symbol of the monitoring occasion for the second search space set 601, the type of the search space set to which the first search space set 600 belongs is different from the type of the search space set to which the second search space set 601 belongs, and at least one of the first control resource set 60 and the control resource set 61 is configured with the parameter pdcch-DMRS-ScramblingID, the first CCE 6000 and the second CCE 6010 may be determined to be non-overlapped CCEs. Here, an index of the first CCE 6000 may be the same as or different from an index of the second CCE 6010. Here, a subcarrier to which the first CCE 6000 corresponds may be the same as or different from a subcarrier to which the second CCE 6010 corresponds. Here, resource elements of the first CCE 6000 may be the same as or different from resource elements of the second CCE 6010.

In a fifth example, in a case that the first control resource set 60 is configured with the first search space set 600 and the first PDCCH candidate 6001 included in the first search space set 600 is mapped to at least the first CCE 6000, the first control resource set 60 is configured with the second search space set 601 and the second PDCCH candidate 6011 included in the second search space set 601 is mapped to at least the second CCE 6010, the first OFDM symbol of the monitoring occasion for the first search space set 600 is the same as the first OFDM symbol of the monitoring occasion for the second search space set 601, the type of the search space set to which the first search space set 600 belongs is different from the type of the search space set to which the second search space set 601 belongs, and the value N_{ID} used for initializing the scrambling sequence c(i) for a first DMRS sequence for the first PDCCH candidate 6001 is different from the value N_{ID} used for initializing the scrambling sequence c(i) for a second DMRS sequence for the second PDCCH candidate 6011, the first CCE 6000 and the second CCE 6010 may be determined to be non-overlapped CCEs. Here, an index of the first CCE 6000 may be the same as or different from an index of the second CCE 6010. Here, a subcarrier to which the first CCE 6000 corresponds may be the same as or different from a subcarrier to which the second CCE 6010 corresponds. Here, resource elements of the first CCE 6000 may be the same as or different from resource elements of the second CCE 6010.

In a sixth example, in a case that the first control resource set 60 is configured with the first search space set 600 and the first PDCCH candidate 6001 included in the first search space set 600 is mapped to at least the first CCE 6000, the first control resource set 60 is configured with the second search space set 601 and the second PDCCH candidate 6011 included in the second search space set 601 is mapped to at least the second CCE 6010, and the first OFDM symbol of the monitoring occasion for the first search space set 600 is the same as the first OFDM symbol of the monitoring occasion for the second search space set 601, the type of the search space set to which the first search space set 600 belongs is the same as the type of the search space set to which the second search space set 601 belongs, and the subcarrier corresponding to the first CCE 6000 is the same as the subcarrier corresponding to the second CCE 6010, the first CCE 6000 and the second CCE 6010 may be determined to be overlapped CCEs.

In a seventh example, in a case that the first control resource set 60 is configured with the first search space set 600 and the first PDCCH candidate 6001 included in the first search space set 600 is mapped to at least the first CCE 6000, the first control resource set 60 is configured with the second search space set 601 and the second PDCCH candidate 6011 included in the second search space set 601 is mapped to at least the second CCE 6010, the first OFDM symbol of the monitoring occasion for the first search space set 600 is the same as the first OFDM symbol of the monitoring occasion for the second search space set 601, the type of the search space set to which the first search space set 600 belongs is different from the type of the search space set to which the second search space set 601 belongs, the first control resource set 60 is not configured with the parameter pdcch-DMRS-ScramblingID, and the subcarrier corresponding to the first CCE 6000 is the same as the subcarrier corresponding to the second CCE 6010, the first CCE 6000 and the second CCE 6010 may be determined to be overlapped CCEs.

In an eighth example, in a case that the first control resource set 60 is configured with the first search space set 600 and the first PDCCH candidate 6001 included in the first search space set 600 is mapped to at least the first CCE 6000, the first control resource set 60 is configured with the second search space set 601 and the second PDCCH candidate 6011 included in the second search space set 601 is mapped to at least the second CCE 6010, the first OFDM symbol of the monitoring occasion for the first search space set 600 is the same as the first OFDM symbol of the monitoring occasion for the second search space set 601, the type of the search space set to which the first search space set 600 belongs is different from the type of the search space set to which the second search space set 601 belongs, the value N_{ID} used for initializing the scrambling sequence c(i) for the first DMRS sequence for the first PDCCH candidate 6001 is the same as the value N_{ID} used for initializing the scrambling sequence c(i) for the second DMRS sequence for the second PDCCH candidate 6011, and the subcarrier corresponding to the first CCE 6000 is the same as the subcarrier corresponding to the first CCE 6000, the first CCE 6000 and the second CCE 6010 may be determined to be overlapped CCEs.

In the sixth to eighth examples, a condition that a subcarrier corresponding to a first CCE is the same as a subcarrier corresponding to a second CCE may be a condition that an index of the first CCE is the same as an index of the second CCE, or a condition that a resource element corresponding to the first CCE is the same as a resource element corresponding to the second CCE.

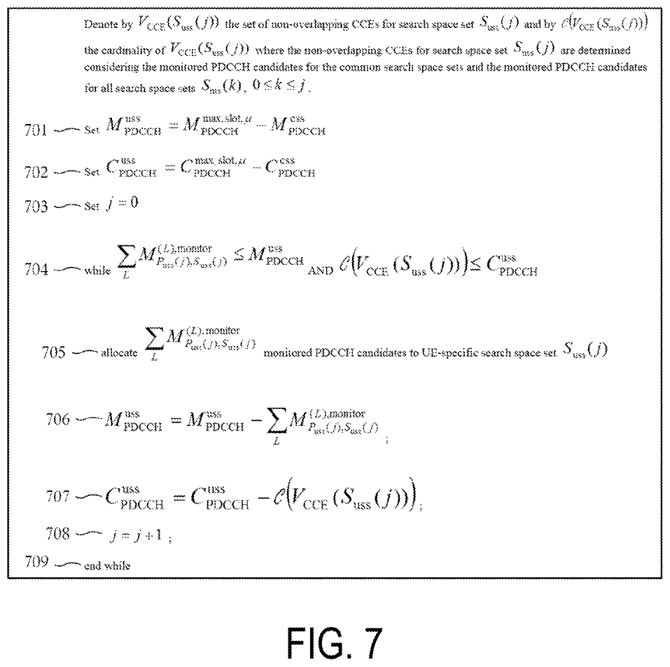

FIG. 7 illustrates a procedure for allocating the number of non-overlapped CCEs that can be used for a search space set (e.g., a j-th search space set) and the number of monitorable PDCCH candidates in a slot according to the present disclosure.

In FIG. 7, M_{PDCCH}^{max,slot,μ} is the maximum number of PDCCH candidates that the terminal apparatus is expected to monitor for each slot and may be defined according to the subcarrier spacing configuration μ. Moreover, C_{PDCCH}^{max,slot,μ} is the maximum number of non-overlapped CCEs that the terminal apparatus is expected to monitor for each slot and may be defined according to the subcarrier spacing configuration μ. Moreover, M_{PDCCH}^{css} is the total number of PDCCH candidates allocated to a CSS type search space set in a slot. Moreover, C_{PDCCH}^{css} is the total number of non-overlapped CCEs allocated to the CSS type search space set in the slot.

The number of non-overlapped CCEs for the j-th search space set may be determined according to the number of monitored PDCCH candidates for the CSS type search space set and the number of monitored PDCCH candidates for the search space sets up to the k-th search space set (0≤k≤j).

In step 701, the predetermined number M_{PDCCH}^{uss} of PDCCH candidates for a USS type search space set may be provided according to the predetermined number M_{PDCCH}^{css} of PDCCH candidates for the CSS type search space set. For example, the predetermined number M_{PDCCH}^{uss} of PDCCH candidates for the USS type search space set may be set to M_{PDCCH}^{max,slot,μ}-M_{PDCCH}^{css}.

In step 702, the predetermined number C_{PDCCH}^{uss} of non-overlapped CCEs for the USS type search space set may be provided according to the predetermined number C_{PDCCH}^{CSS} of non-overlapped CCEs for the CSS type search space set. For example, the predetermined number C_{PDCCH}^{uss} of non-overlapped CCEs for the USS type search space set may be set to c_{PDCCH}^{max,slot,μ}-C_{PDCCH}^{css}.

In step 703, the variable j is set to 0.

In step 704, in a case that a predetermined condition C is satisfied, a predetermined process may be performed. The predetermined process may include at least some of the following steps 705 to 708.

Step 705: One or multiple PDCCH candidates to be monitored is allocated to the j-th USS type search space set Sᵤₛₛ(j).

Step 706: The number M_{PDCCH}^{uss} of remaining PDCCH candidates is set to a value obtained by subtracting the number ΣM_{Puss(j),Suss(j)}^{(L),monitor} of PDCCH candidates for the j-th USS type search space set Sᵤₛₛ(j) from the number M_{PDCCH}^{uss} of remaining PDCCH candidates. For example, the number M_{PDCCH}^{uss} of remaining PDCCH candidates may be set to the number M_{PDCCH}^{uss} of remaining PDCCH candidates −ΣM_{Puss(j),Suss(j)}^{(L),monitor}.

Step 707: The number C_{PDCCH}^{uss} of remaining non-overlapped CCEs is set to a value obtained by subtracting the number C(V_{CCE}(Sᵤₛₛ(j))) of non-overlapped CCEs allocated to the j-th USS type search space set Sᵤₛₛ(j) from the number C_{PDCCH}^{uss} of remaining non-overlapped CCEs. For example, the number C_{PDCCH}^{uss} of remaining non-overlapped CCEs may be set to C_{PDCCH}^{uss}-C(V_{CCE}(Sᵤₛₛ(j))).

Step 708: j is set to j+1.

After step 708 is performed, the process returns to step 704.

In step 704, in a case that the predetermined condition C is not satisfied, the predetermined process stops. Alternatively, in the case that the predetermined condition C is not satisfied in step 704, the process may proceed to step 709.

The predetermined condition C may at least include a condition that the number C(V_{CCE}(Sᵤₛₛ(j))) of non-overlapped CCEs for the j-th USS type search space set does not exceed CPDCCH^{uss} (the total number of residual (or remaining) non-overlapped CCEs after the non-overlapped CCEs are allocated to the 0-th to j−1-th USS type search space sets). Furthermore, the predetermined condition C may include at least a condition that the number ΣM_{Puss(j),Suss(j)}^{(L),monitor} of PDCCH candidates for the j-th USS type search space set does not exceed M_{PDCCH}^{uss} (the total number of residual (or remaining) PDCCH candidates after the monitored PDCCH candidates are allocated to the 0-th to j−1-th USS type search space sets).

Various aspects of apparatuses according to the present disclosure will be described subsequently.

Aspects of the present disclosure provide the following benefits. Specifically, a first aspect of the present disclosure is a terminal apparatus including a receiver configured to monitor a search space set of a control resource set, wherein a physical downlink control channel (PDCCH) candidate to be monitored is allocated to the search space set, based at least on a maximum number CPDCCH^{max,slot} of non-overlapped control channel elements (CCEs) expected to be monitored by the terminal apparatus in a slot and, in a case that the control resource set satisfies at least one of multiple conditions, the CCE is a CCE of the non-overlapped CCEs, and the multiple conditions include a condition where the CCE corresponds to different types of the search space set.

A second aspect of the present disclosure is a terminal apparatus including a receiver configured to monitor a search space set of a control resource set, wherein a physical downlink control channel (PDCCH) candidate to be monitored is allocated to the search space set, based at least on a maximum number C_{PDCCH}^{max,slot} of non-overlapped control channel elements (CCEs) expected to be monitored by the terminal apparatus in a slot and, in a case that a CCE satisfies at least one of multiple conditions, the CCE is a CCE of the non-overlapped CCEs, and the multiple conditions include a condition where a higher-layer parameter pdcch-DMRS-ScramblingID of the control resource set is configured and a condition where the CCE corresponds to different types of the search space set.

In the first aspect of the present disclosure and the second aspect of the present disclosure, the types of the search space set include a CSS and a USS.

A third aspect of the present disclosure is a base station apparatus including a receiver configured to monitor a search space set of a control resource set, wherein a physical downlink control channel (PDCCH) candidate to be monitored is allocated to the search space set, based at least on a maximum number C_{PDCCH}^{max,slot} of non-overlapped control channel elements (CCEs) expected to be monitored by the terminal apparatus in a slot and, in a case that the control resource set satisfies at least one of multiple conditions, the CCE is a CCE of the non-overlapped CCEs, and the multiple conditions include a condition where the CCE corresponds to different types of the search space set.

A fourth aspect of the present disclosure is a base station apparatus including a receiver configured to monitor a search space set of a control resource set, wherein a physical downlink control channel (PDCCH) candidate to be monitored is allocated to the search space set, based at least on a maximum number C_{PDCCH}^{max,slot} of non-overlapped control channel elements (CCEs) expected to be monitored by the terminal apparatus in a slot and, in a case that a CCE satisfies at least one of multiple conditions, the CCE is a CCE of the non-overlapped CCEs, and the multiple conditions include a condition where a higher-layer parameter pdcch-DMRS-ScramblingID of the control resource set is configured and a condition where the CCE corresponds to different types of the search space set.

In the third aspect of the present disclosure and the fourth aspect of the present disclosure, the types of the search space set include a CSS and a USS.

A program running on each of the base station apparatus 3 and the terminal apparatus 1 according to the present disclosure may be a program that controls a Central Processing Unit (CPU) and the like (a program that causes a computer to function), such that the program realizes the functions of the previous disclosure. The information processed in these devices is temporarily stored in a Random Access Memory (RAM) while being processed. Thereafter, the information is stored in various types of Read Only Memory (ROM) such as a Flash ROM and a Hard Disk Drive (HDD), and when necessary, is read by the CPU to be modified or rewritten.

The terminal apparatus 1 and the base station apparatus 3 may be partially achieved by a computer. In such a case, a program for realizing such control functions may be recorded on a computer-readable recording medium to cause a computer system to read the program recorded on the recording medium for execution.

It is assumed that the “computer system” refers to a computer system built into the terminal apparatus 1 or the base station apparatus 3, and the computer system includes an Operating System (OS) and hardware components such as a peripheral apparatus. Furthermore, a “computer-readable recording medium” refers to a portable medium such as a flexible disk, a magneto-optical disk, a ROM, a CD-ROM, and the like, and a storage device such as a hard disk built into the computer system.

The “computer-readable recording medium” may include a medium that dynamically retains the program for a short period of time, such as a communication line that is used to transmit the program over a network such as the Internet or over a communication line such as a telephone line, and a medium that retains the program for a certain period of time, such as a volatile memory within the computer system which functions as a server or a client. The program may be configured to perform some of the functions previously disclosed, and also may be configured to be capable of performing the functions previously disclosed in combination with a program already recorded in the computer system.

Furthermore, the base station apparatus 3 may be an aggregation (apparatus group) including multiple apparatuses. Each of the apparatuses may include some or all portions of each function or each functional block of the base station apparatus 3 according to the previous disclosure. The apparatus group is required to have a complete set of functions or functional blocks of the base station apparatus 3. Furthermore, the terminal apparatus 1 according to the previous disclosure can also communicate with the base station apparatus as the aggregation.

The base station apparatus 3 may be the Evolved Universal Terrestrial Radio Access Network (EUTRAN) and/or the NextGen RAN, NR RAN (NG-RAN). The base station apparatus 3 according to the previous disclosure may have some of the functions of a higher node for an eNodeB and/or a gNB.

Furthermore, some or all portions of each of the terminal apparatus 1 and the base station apparatus 3 may be achieved as an Large Scale Integration (LSI) which is an integrated circuit or may be a chip set. The functional blocks of each of the terminal apparatus 1 and the base station apparatus 3 may be an individual chip, or some of the functional blocks may be integrated into a chip. A circuit integration technique is not limited to the LSI, and may be a dedicated circuit or a general-purpose processor. Furthermore, with advances in semiconductor technology in which a circuit integration technology replaces an LSI, it is also possible to use an integrated circuit based on the advanced technology.

Furthermore, according to the previous disclosure, the terminal apparatus has been described as an example of a communication apparatus, but the present disclosure is not limited to such a terminal apparatus, and is applicable to a terminal apparatus or a communication apparatus of a fixed-type or a stationary-type electronic apparatus installed indoors or outdoors, such as an Audio-Visual (AV) apparatus.

The present disclosure has been described in detail with reference to the drawings, but the specific disclosed configurations are not limited to the present disclosure and include, for example, any alteration to a design that falls within the scope of the present disclosure that does not depart from the gist of the present disclosure. Various modifications are possible within the scope of the present disclosure as defined by claims, and by suitably combining technical means disclosed according to the different embodiments are also included in the technical scope of the present disclosure. Furthermore, a configuration in which elements, disclosed in the respective embodiments and having mutually the same effects, are substituted for one another is also included in the technical scope of the present disclosure.

1. A terminal apparatus for performing communication, the terminal apparatus comprising:
a receiver configured to monitor a search space set of a control resource set, wherein
a physical downlink control channel (PDCCH) candidate to be monitored is allocated to the search space set, based at least on a maximum number C_{PDCCH}^{max,slot} of non-overlapped control channel elements (CCEs) expected to be monitored by the terminal apparatus in a slot;
in a case that the control resource set satisfies at least one of multiple conditions, the CCE that is monitored is one of the non-overlapped and CCEs; and
the multiple conditions include a condition where the CCE that is monitored corresponds to different types of the search space set.

2. The terminal apparatus according to claim 1, wherein the multiple conditions further include a condition where a higher-layer parameter pdcch-DMRS-ScramblingID of the control resource set is configured.

3. The terminal apparatus according to claim 1, wherein the different types of the search space set include a common search space (CSS) and a UE-specific search space (USS).

4. A base station apparatus comprising:
a transmitter configured to transmit a physical downlink control channel (PDCCH) in a search space set of a control resource set, wherein;
a PDCCH candidate to be monitored is allocated to the search space set, based at least on a maximum number C_{PDCCH}^{max,slot} of non-overlapped control channel elements (CCEs) expected to be monitored by a terminal apparatus in a slot;
in a case that the control resource set satisfies at least one of multiple conditions, the CCE expected to be monitored is one of the non-overlapped CCEs; and
the multiple conditions include a condition where the CCE expected to monitored corresponds to different types of the search space set.

5. The base station apparatus of claim 4, wherein the multiple conditions include a condition where a higher-layer.

6. The base station apparatus according to claim 4, wherein the different types of the search space set include a common search space (CSS) and a UE-specific search space (USS).

7. A communication method of a terminal apparatus for performing communication, the communication method comprising:
monitoring a search space set of a control resource set, wherein;
a physical downlink control channel (PDCCH) candidate to be monitored is allocated to the search space set, based at least on a maximum number C_{PDCCH}^{max,slot} of non-overlapped control channel elements (CCEs) expected to be monitored by the terminal apparatus in a slot;
in a case that the control resource set satisfies at least one of multiple conditions, the CCE expected to be monitored is on of the non-overlapped CCEs; and
the multiple conditions include a condition where the CCE expected to be monitored corresponds to different types of the search space set.

8. The communication method according to claim 7, wherein
the multiple conditions further include a condition where a higher-layer parameter pdcch-DMRS-ScramblingID of the control resource set is configured.
